(19) United States
(12) Patent Application Publication
(10) Pub. No.: US 2025/0317082 A1
(43) Pub. Date: Oct. 9, 2025

(54) METHOD FOR FIELD-ORIENTED CURRENT CONTROL OF MOTOR CURRENTS OF AN ELECTRIC MOTOR

(71) Applicant: Schaeffler Technologies AG & Co. KG, Herzogenaurach (DE)

(72) Inventors: Waldemar Funk, Gräfenberg (DE); Michael Wiesinger, Obertraubling (DE); Steven Maertens, Toulouse (FR)

(73) Assignee: Schaeffler Technologies AG & Co. KG, Herzogenaurach (DE)

(21) Appl. No.: 19/244,224

(22) Filed: Jun. 20, 2025

Related U.S. Application Data
(63) Continuation of application No. PCT/EP2023/086652, filed on Dec. 19, 2023.

(30) Foreign Application Priority Data
Dec. 22, 2022 (DE) 10 2022 214 301.9

(51) Int. Cl. H02P 21/09; H02P 21/22

(52) U.S. Cl. CPC H02P 21/09; H02P 21/22

(57) ABSTRACT

A method for field-oriented current control of motor currents of an electric motor is provided. The motor voltage is limited by a maximum voltage. A field-weakening controller corrects setpoint values of reference variables for the current control when a motor voltage exceeding the maximum voltage is required to control the motor currents to the setpoint values. A calibration value of a rotor position offset angle between a rotor of the electric motor and a position sensor system configured to determine a rotor position of the rotor is learned by a calibration of the position sensor system and stored. Furthermore, a value of the rotor position offset angle, used for the determination of the setpoint values in operation of the electric motor using a motor voltage which is at least approximately the maximum voltage, is changed in relation to the calibration value by a change value.

### CROSS-REFERENCE TO RELATED APPLICATIONS

This application claims the benefit of PCT Application PCT/EP2023/086652, filed Dec. 19, 2023, which claims priority to German Application DE 10 2022 214 301.9, filed Dec. 22, 2022. The disclosures of the above applications are incorporated herein by reference.

### TECHNICAL FIELD

The disclosure relates to a method for field-oriented current control of motor currents of an electric motor.

### BACKGROUND

In the field-oriented current control of motor currents of an electric motor, the variables used for control, such as motor currents and motor voltages, are related to a rotor-fixed coordinate system, i.e. a coordinate system rotating with the rotor of the electric motor. Therefore, the rotor position of the rotor is required with sufficient accuracy for the control. In general, a position sensor system is used for determining the rotor position.

To determine the rotor position using a position sensor system, it is necessary to know a rotor position offset angle between the rotor of the electric motor and the position sensor system. The rotor position offset angle is generally learned once by way of a calibration method, for example, for a reference motor. However, each calibration method for determining the rotor position offset angle only has a finite accuracy. Inaccuracies of the rotor position offset angle in the field-oriented current control of the motor currents of an electric motor can result in a significant loss of performance and efficiency of the electric motor.

### SUMMARY

The disclosure provides a method for field-oriented current control of motor currents of an electric motor, which reduces a loss of performance and efficiency due to inaccuracy of the determination of the rotor position offset angle.

The method relates to the field-oriented current control of motor currents of an electric motor, the motor voltage of which is limited by a maximum voltage, using a field-weakening controller configured to correct setpoint values of reference variables for the current control if a motor voltage which exceeds the maximum voltage would be necessary to control the motor currents to the setpoint values. In the method, initially a calibration value of a rotor position offset angle between a rotor of the electric motor and a position sensor system configured to determine a rotor position of the rotor is learned by a calibration of the position sensor system and stored. In operation of the electric motor using a motor voltage which is at least approximately the maximum voltage, a value of the rotor position offset angle used for the determination of the setpoint values is changed in relation to the calibration value by a change value such that a motor voltage which exceeds the maximum voltage would be necessary to control the reference variables to the setpoint values.

Implementations of the disclosure may include one or more of the following optional features. In some implementations, the method uses a field-weakening controller, which automatically corrects setpoint values of reference variables for the current control if the setpoint values are not implementable since they require a motor voltage which exceeds the maximum voltage. In some examples, this property of the field-weakening controller is used in operation of the electric motor with a motor voltage which is at least approximately the maximum voltage. A value of the rotor position offset angle used for the determination of setpoint values is deliberately changed here in relation to the calibration value by a change value such that a motor voltage which exceeds the maximum voltage would be necessary to control the reference variables to the setpoint values. This activates the field-weakening controller and results in an automatic correction of the setpoint values of the reference variables by the field-weakening controller. Finally, an efficiency-optimum load point for the operation of the electric motor is achieved by the tracking of the setpoint values. To avoid disadvantages due to the adaptation of the value of the rotor position offset angle in the base speed range of the electric motor, the adaptation is only used if a degree of modulation of the motor voltage, i.e. a ratio of the motor voltage to the maximum voltage, is at least approximately maximum.

In some implementations, components of a current vector of the motor current in a d/q coordinate system for the motor current are used as reference variables. A d/q coordinate system is understood as a rotor-fixed coordinate system having axes perpendicular to one another, which are typically designated as the d axis and q axis. The components of a current vector of the motor current in such a coordinate system are designated as the d component and q component of the motor current.

In some examples, the setpoint values of the reference variables are determined as a function of a required torque of the electric motor, a required speed of the electric motor, a rotor temperature of the rotor of the electric motor, and/or the maximum voltage.

In some implementations, in the correction of the setpoint values by the field-weakening controller, a value of a maximum voltage utilization used in the determination of the setpoint values, which specifies a maximum ratio of the motor voltage to the maximum voltage, is replaced by a value which corresponds to a reduced maximum voltage utilization. In other words, the maximum voltage utilization is thus artificially reduced to cause a correction of the setpoint values.

In some examples, the change value for the rotor position offset angle corresponds to a tolerance accuracy of the calibration of the position sensor system. The change value for the rotor position offset angle is thus matched to the accuracy of the calibration of the position sensor system.

In some implementations, the maximum voltage corresponds to a battery voltage provided by a battery for operating the electric motor and a selected modulation method for a control of electronic switches of a pulse inverter for implementing the motor voltage. For example, the electric motor is the motor of an electric vehicle and the battery is a rechargeable battery of the electric vehicle.

In some examples, the maximum voltage is related to a d/q coordinate system for the motor voltage.

In some implementations, the field-weakening controller is implemented as a software module. For example, the disclosure is then implementable solely via software and therefore does not require any additional hardware. The torque quality, performance quality, and efficiency quality of the electric motor can therefore be increased at no cost.

In some examples, a correction of the calibration value of the rotor position offset angle is determined from the correction of setpoint values of the reference variables. For example, the correction of the calibration value of the rotor position offset angle is determined such that the use of the corrected calibration value in the determination of setpoint values of the reference variables results in an improvement of the efficiency of the electric motor in relation to the use of the calibration value. The above-mentioned design of the disclosure is thus directed to a correction of the calibration value of the rotor position offset angle itself and therefore to an overall improved field-oriented current control of the motor currents of the electric motor.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 shows an MTPA curve and current vectors in two quadrants of a d/q coordinate system for the motor current of an electric motor,

FIG. 2 shows a block diagram of a field-weakening controller,

FIG. 3 shows curves of fixed voltage utilization in two quadrants of a d/q coordinate system for the motor current of an electric motor.

Like reference symbols in the various drawings indicate like elements.

### DETAILED DESCRIPTION

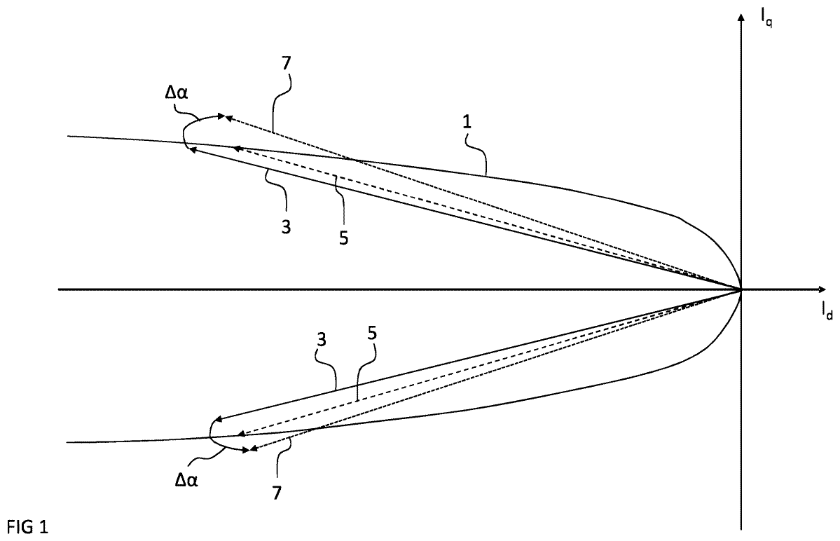

FIGS. 1 to 3 illustrate an exemplary method for field-oriented current control of motor currents I_{d}, I_{q} of an electric motor. A motor voltage of the electric motor is limited by a maximum voltage U_{s,max}. For example, the electric motor is a motor which is supplied with electrical energy from a battery, where the motor voltage of the electric motor is generated from a battery voltage of the battery by a pulse inverter. The pulse inverter includes electronic switches which are actuated such that the motor voltage (AC voltage) of the electric motor is generated from the battery voltage (DC voltage) of the battery. For example, the electronic switches are actuated in a pulse-width modulated manner. The maximum voltage U_{s,max} of the motor voltage results from the battery voltage of the battery and the modulation method for the actuation of the electronic switches of the pulse inverter. For example, the electric motor is the motor of an electric vehicle and the battery is a rechargeable battery of the electric vehicle.

The reference variables of the current control of the motor current are a d component I_{d} and a q component I_{q} of the motor current in a d/q coordinate system co-rotating with a rotor of the electric motor. These reference variables are determined as a function of a required torque of the electric motor, a required speed of the electric motor, a rotor temperature of the rotor of the electric motor, and the maximum voltage U_{s,max}.

The manipulated variables of the current control of the motor current are a d component of the motor voltage corresponding to the d component I_{d} of the motor current and a q component of the motor voltage corresponding to the q component I_{q} of the motor current in a d/q coordinate system for the motor voltage.

In some implementations, the method is implemented using a field-weakening controller 9 implemented as a software module. The field-weakening controller 9 is configured to correct setpoint values for the motor currents I_{d}, I_{q} of the current control if a motor voltage would be required to control the motor currents I_{d}, I_{q} to the setpoint values which exceeds the maximum voltage U_{s,max}.

In some examples, first a calibration value of a rotor position offset angle between a rotor of the electric motor and a position sensor system configured to determine a rotor position of the rotor is learned once by a calibration of the position sensor system and stored.

The value of the rotor position offset angle is used to determine the setpoint values of the components I_{d}, I_{q} of the motor current. In some examples, the value of the rotor position offset angle used for the determination of the setpoint values for I_{d}, I_{q} is changed, in operation of the electric motor using a motor voltage which is at least approximately the maximum voltage U_{s,max}, in relation to the calibration value by a change value Δα such that a motor voltage which exceeds the maximum voltage U_{s,max} would be required to control the components I_{d}, I_{q} of the motor current to the setpoint values.

FIG. 1 (FIG. 1) shows an exemplary two quadrants of a d/q coordinate system for the motor current having the components I_{d}, I_{q} and an MTPA curve 1 (MTPA=maximum torque per ampere) on each of the points of which a torque of the electric motor is implemented using a minimum motor current. Except for an area of low motor currents, the points of the MTPA curve 1 are also those points for which a maximum voltage utilization VU_{Lim} of the motor voltage is achieved, i.e. a maximum ratio of the motor voltage to the maximum voltage U_{s,max}. For example, FIG. 1 furthermore shows a current vector 3 for each of the two quadrants of the d/q coordinate system shown, in which the motor voltage is approximately the maximum voltage U_{s,max}, an ideal current vector 5 which implements a point on the MTPA curve 1, and an imaginary current vector 7, the components of which would result as setpoint values for the motor current components I_{d}, I_{q} with the calibration value of the rotor position offset angle changed by the change value Δα in each case instead of the components of the current vector 3. FIG. 1 shows that the change value Δα, such as the sign of this change value Δα, depends on the quadrant of the d/q coordinate system for the motor current.

The change of the value of the rotor position offset angle used for the determination of the setpoint values for the components I_{d}, I_{q} by the change value Δα activates the field-weakening controller 9, since the change value Δα is selected such that a motor voltage which exceeds the maximum voltage U_{s,max} would be required to control the components I_{d}, I_{q} of the motor current to the setpoint values. The field-weakening controller 9 therefore automatically corrects the setpoint values for the components I_{d}, I_{q} of the motor current.

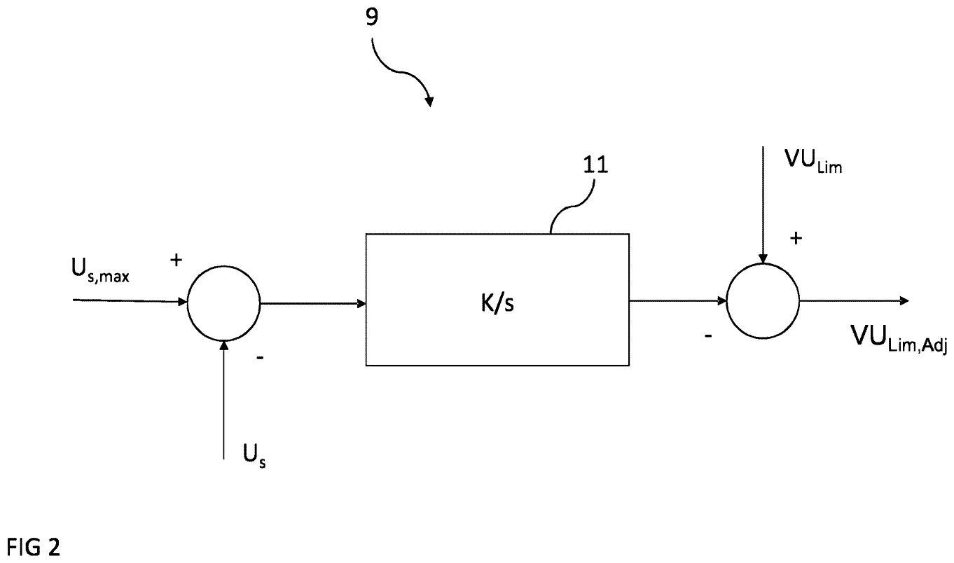

FIG. 2 (FIG. 2) shows a block diagram of the field-weakening controller 9. The input variables of the field-weakening controller 9 are the maximum voltage U_{s,max}, a required voltage Uₛ, and a maximum voltage utilization VU_{Lim} of the motor voltage. The required voltage Uₛ is a motor voltage which is required to generate a motor current that causes the required torque of the electric motor and the required speed of the electric motor as a function of the rotor temperature of the rotor of the electric motor and the maximum voltage U_{s,max}. The output variable of the field-weakening controller 9 is an (artificially) reduced maximum voltage utilization VU_{Lim,Adj}. The field-weakening controller 9 initially subtracts the required voltage Uₛ from the maximum voltage U_{s,max}. The result of this subtraction is supplied to an I element 11 (integration element). The output value of the I element 11 is subtracted from the maximum voltage utilization VU_{Lim}. The result of this subtraction is the reduced maximum voltage utilization VU_{Lim,Adj}, which causes the correction of the setpoint values for the components I_{d}, I_{q} of the motor current.

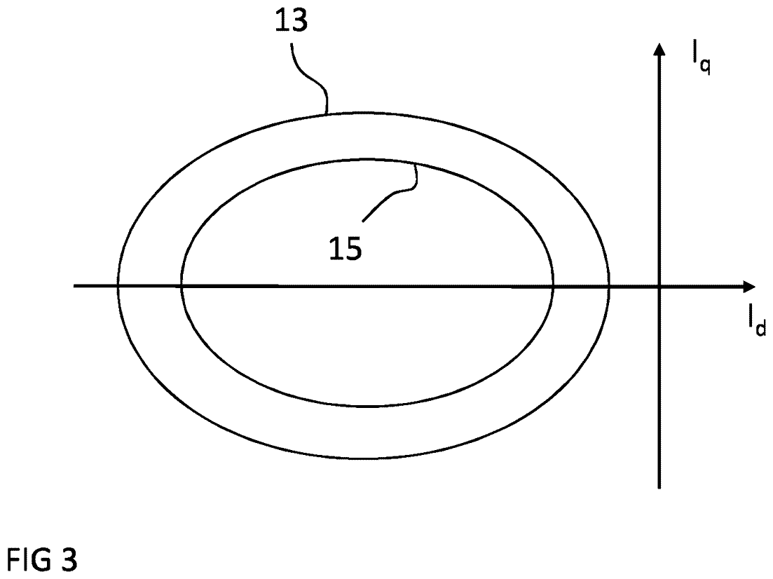

FIG. 3 (FIG. 3) shows curves 13, 15 of fixed voltage utilization in the two quadrants of a d/q coordinate system for the motor current already shown in FIG. 1. The points on the curve 13 implement the maximum voltage utilization VU_{Lim} and the points on the curve 15 implement a voltage utilization VU_{Lim,Adj} reduced in relation to VU_{Lim}.

A number of implementations have been described. Nevertheless, it will be understood that various modifications may be made without departing from the spirit and scope of the disclosure. Accordingly, other implementations are within the scope of the following claims.

### REFERENCE NUMERALS

1 MTPA curve
3 current vector
5 ideal current vector
7 imaginary current vector
9 field-weakening controller
11 I element
13, 15 curves of fixed voltage utilization
Δα change value
Uₛ required voltage
U_{s,max} maximum voltage
VU_{Lim} maximum voltage utilization
VU_{Lim,Adj} reduced maximum voltage utilization

What is claimed is:

1. A method for field-oriented current control of motor currents of an electric motor using a field-weakening controller, a motor voltage of the electric motor is limited by a maximum voltage, the field-weakening controller corrects setpoint values of reference variables for the current control when the motor voltage exceeds the maximum voltage resulting in control of the motor currents to the setpoint values, the method comprises:
providing a position sensor system configured to determine a rotor position of the rotor;
providing a rotor of the electric motor;
calibrating the position sensor system;
determining a calibration value of a rotor position offset angle between the rotor of the electric motor and the position sensor system;
storing the calibration value of the rotor position offset angle;
changing a value of the rotor position offset angle based on the calibration value by a change value;
determining setpoint values in operation of the electric motor using a motor voltage which is at least approximately the maximum voltage based on the value of the rotor position offset angle, wherein a motor voltage which exceeds the maximum voltage controls the reference variables to the setpoint values.

2. The method of claim 1, wherein the reference variables include components of a current vector of the motor current in a d/q coordinate system for the motor current.

3. The method of claim 1, wherein the setpoint values of the reference variables are determined as a function of a required torque of the electric motor, a required speed of the electric motor, a rotor temperature of the rotor of the electric motor, and/or the maximum voltage.

4. The method of claim 1, further comprising:
correcting of the setpoint values by the field-weakening controller, a value of a maximum voltage utilization, which specifies a maximum ratio of the motor voltage to the maximum voltage, used in the determination of the setpoint values is replaced by a value which corresponds to a reduced maximum voltage utilization.

5. The method of claim 1, wherein the change value for the rotor position offset angle corresponds to a tolerance accuracy of the calibration of the position sensor system.

6. The method of claim 1, wherein the maximum voltage corresponds to a battery voltage provided by a battery for operating the electric motor and a selected modulation method for a control of electronic switches of a pulse inverter for implementing the motor voltage.

7. The method of claim 1, wherein the maximum voltage is related to a d/q coordinate system for the motor voltage.

8. The method of claim 1, wherein the field-weakening controller is implemented as a software module.

9. The method of claim 1, wherein a correction of the calibration value of the rotor position offset angle is determined from the correction of setpoint values of the reference variables.

10. The method of claim 9, wherein the correction of the calibration value of the rotor position offset angle is determined such that the use of the corrected calibration value in the determination of setpoint values of the reference variables results in an improvement of the efficiency of the electric motor in relation to the use of the calibration value.

11. A method for field-oriented current control of motor currents of an electric motor, a motor voltage of which is limited by a maximum voltage, using a field-weakening controller configured to correct setpoint values of reference variables for the current control if a motor voltage which exceeds the maximum voltage would be required to control the motor currents to the setpoint values, wherein:
a calibration value of a rotor position offset angle between a rotor of the electric motor and a position sensor system configured to determine a rotor position of the rotor is learned by a calibration of the position sensor system and stored and
a value of the rotor position offset angle, used for the determination of the setpoint values in operation of the electric motor using a motor voltage which is at least approximately the maximum voltage, is changed in relation to the calibration value by a change value such that a motor voltage which exceeds the maximum voltage would be required to control the reference variables to the setpoint values.

12. The method of claim 11, wherein components of a current vector of the motor current in a d/q coordinate system for the motor current are used as reference variables.

13. The method of claim 11, wherein the setpoint values of the reference variables are determined as a function of a required torque of the electric motor, a required speed of the electric motor, a rotor temperature of the rotor of the electric motor, and/or the maximum voltage.

14. The method of claim 11, wherein in a correction of the setpoint values by the field-weakening controller, a value of a maximum voltage utilization, which specifies a maximum ratio of the motor voltage to the maximum voltage, used in the determination of the setpoint values is replaced by a value which corresponds to a reduced maximum voltage utilization.

15. The method of claim 11, wherein the change value for the rotor position offset angle corresponds to a tolerance accuracy of the calibration of the position sensor system.

16. The method of claim 11, wherein the maximum voltage corresponds to a battery voltage provided by a battery for operating the electric motor and a selected modulation method for a control of electronic switches of a pulse inverter for implementing the motor voltage.

17. The method of claim 11, wherein the maximum voltage is related to a d/q coordinate system for the motor voltage.

18. The method of claim 11, wherein the field-weakening controller is implemented as a software module.

19. The method of claim 11, wherein a correction of the calibration value of the rotor position offset angle is determined from the correction of setpoint values of the reference variables.

20. The method of claim 19, wherein the correction of the calibration value of the rotor position offset angle is determined such that the use of the corrected calibration value in the determination of setpoint values of the reference variables results in an improvement of the efficiency of the electric motor in relation to the use of the calibration value.
